(19) United States
(12) Patent Application Publication
(10) Pub. No.: US 2025/0048452 A1
(43) Pub. Date: Feb. 6, 2025

(54) C-TDMA Protocols, TXOP Sharing Modes For Time Allocation, And Exchange Of Parameters In Multi-AP Systems

(71) Applicant: MediaTek Inc., Hsinchu City (TW)

(72) Inventors: Samat Shabdanov, San Jose, CA (US); Po-Chun Fang, Hsinchu City (TW); Cheng-Chien Su, Hsinchu City (TW); James Chih-Shi Yee, San Jose, CA (US); Chien-Fang Hsu, Hsinchu City (TW); You-Wei Chen, San Jose, CA (US); Chung-Ta Ku, San Jose, CA (US); Weisung Tsao, San Jose, CA (US); Po-Yuen Cheng, San Jose, CA (US)

(21) Appl. No.: 18/789,653

(22) Filed: Jul. 30, 2024

Related U.S. Application Data
(60) Provisional application No. 63/517,622, filed on Aug. 4, 2023.
(60) Provisional application No. 63/644,581, filed on May 9, 2024.

(51) Int. Cl. H04W 74/0833; H04J 3/06; H04W 48/16

(52) U.S. Cl. CPC H04W 74/085; H04J 3/0629; H04W 48/16

(57) ABSTRACT

Various schemes pertaining to coordinated time-division multiple-access (C-TDMA) protocols, transmission opportunity (TXOP) sharing modes for time allocation, and exchange of parameters in multi-access point (multi-AP) systems are described. An apparatus (e.g., a sharing access point (AP)) acquires a TXOP. The apparatus also triggers one or more shared APs to participate in C-TDMA communications with respectively associated stations (STAs) within the TXOP.

### CROSS REFERENCE TO RELATED PATENT APPLICATION

The present disclosure is part of a non-provisional patent application claiming the priority benefit of U.S. Provisional Patent Application Nos. 63/517,622 and 63/644,581, filed 4-8-2023 and 9-5-2024, respectively, the contents of which being incorporated by reference in their entirety.

### TECHNICAL FIELD

The present disclosure is generally related to wireless communications and, more particularly, to coordinated time-division multiple-access (C-TDMA)) protocols, transmission opportunity (TXOP) sharing modes for time allocation, and exchange of parameters in multi-access point (multi-AP) systems in wireless communications.

### BACKGROUND

Unless otherwise indicated herein, approaches described in this section are not prior art to the claims listed below and are not admitted as prior art by inclusion in this section.

In wireless communications, such as Wi-Fi (or WiFi) and wireless local area networks (WLANs) in accordance with one or more Institute of Electrical and Electronics Engineers (IEEE) 802.11 standards, multi-AP (MAP) coordination is a key feature in next-generation IEEE 802.11-based networks. In a MAP network there is generally a group of access points (APs) that are connected via wired or wireless backhaul to enable coordination between the APs for resource management and exchange of system parameters.

There exists many coordination techniques that can benefit from MAP such as, for example, coordinated beamforming (CBF), coordinated spatial reuse (CSR), and C-TDMA, among others. Typically, the coordinated techniques share common resources between the APs participating in the MAP. The resource sharing, synchronization, and coordination are managed by a central AP, also known as a sharing AP. An AP in the MAP that wins the contention and acquires a TXOP is a TXOP owner and is designated with the functionalities of a sharing AP. On the other hand, a shared AP refers to an AP that uses a portion of the resources that are allocated (shared) by the sharing AP. In C-TDMA, a sharing AP shares the acquired TXOP with two or more shared APs. For resource management, the coordinated techniques rely on using a variety of physical-layer (PHY) and/or medium access control (MAC) parameters that are known beforehand by all the APs participating in the MAP.

Specifically, in a C-TDMA scheme, the sharing AP acquires a TXOP and allocates portions of the TXOP duration to shared APs using a C-TDMA protocol. The APs in C-TDMA can exchange frames with their associated stations (STAs) only within the allocated times (e.g., in a 3-AP MAP, AP₁ exchange frames with its STAs within allocated time t₁ within the TXOP, AP₂ exchange frames with its STAs within allocated time t₂ within the TXOP, and AP₃ exchange frames with its STAs within allocated time t₃ within the TXOP). The APs participating in C-TDMA do not need to be in the range of each other and thus the APs may act as hidden nodes to each other. In terms of performance, C-TDMA is a technique that aims to reduce latency. To provide a latency gain, C-TDMA requires an efficient resource allocation mechanism and a feasible C-TDMA protocol. If the allocation mechanism is not properly designed, failure in providing a latency gain may result. Other techniques, such as CBF and/or CSR, require a sharing AP to have knowledge of MAC/PHY parameters of shared APs. However, the sharing and exchange of parameters between APs can yield to overhead due to the additional protocol signaling.

In the 3-AP MAP example, a sharing AP employs a resource allocation algorithm to compute TXOP allocation times t₁, t₂ and t₃ within its acquired TXOP. When an algorithmic implementation is not constrained by any requirements, the sharing AP may prioritize its own low-latency traffic over that of shared APs. In such a case, the sharing AP may operate “greedy” by sharing only a relatively small portion of the TXOP with other APs or even may choose not to share at all. This greedy performance behavior tends to lead to starvation at the shared APs. When not fixed, this issue may result in failure of C-TDMA in providing a latency gain. Additionally, C-TDMA also requires a simple and efficient protocol that is crucial to achieving low latency in MAP.

The coordinated transmission schemes rely on knowledge of PHY and/or MAC parameters that need to be shared and/or exchanged between the APs participating in the MAP. Since the inter-AP exchange of parameters reduces system throughput, it is important to find an approach on how to reduce this protocol overhead. For CBF, the parameters that need to be exchanged or shared between the APs include, among others, channel state information (CSI) between APs and STAs, a selection of STAs for transmission, and grouping of spatial streams. For CSR, the parameters that need to be exchanged or shared between the APs include, among others, channel path loss between the APs and STAs, power allocations, and buffer status. For C-TDMA, the parameters that need to be exchanged or shared between the APs include, among others, knowledge of the number of associated STAs, low-latency traffic information, and TXOP allocation times.

Therefore, there is a need for a solution of C-TDMA protocols, TXOP sharing modes for time allocation, and exchange of parameters in multi-AP systems in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to C-TDMA protocols, TXOP sharing modes for time allocation, and exchange of parameters in multi-AP systems in wireless communications. It is believed that implementations of the proposed schemes may address or otherwise alleviate aforementioned issues. For instance, implementations of the proposed schemes may enhance the coordinated MAP techniques with the following: C-TDMA protocols for frame exchanges, a mechanism to address the TXOP sharing issue that incorporates TXOP sharing modes into the MAP negotiation phase, a number of TXOP sharing modes that specify requirements on how to allocate times within a TXOP, and a method to share PHY/MAC resource allocation parameters between APs participating in C-TDMA to reduce protocol overhead by exploiting the broadcast property of beacons.

In one aspect, a method may involve a sharing AP acquiring a TXOP. The method may also involve the sharing AP triggering one or more shared APs to participate in C-TDMA communications with respectively associated STAs within the TXOP.

In another aspect, a method may involve a sharing AP negotiating with one or more shared APs to select a TXOP sharing mode. The method may also involve the sharing AP triggering the one or more shared APs to participate in C-TDMA communications with respectively associated STAs within a TXOP using the selected TXOP sharing mode.

In yet another aspect, a method may involve a shared AP receiving an enhanced variant of multi-user request-to-send (MU-RTS) TXOP sharing (TXS) trigger frame from a sharing AP which acquired a TXOP. The method may also involve the shared AP transmitting a response frame (e.g., a clear-to-send (CTS) frame) to the sharing AP responsive to receiving the enhanced variant of MU-RTS TXS trigger frame. The method may further involve the shared AP exchanging downlink (DL) and uplink (UL) physical-layer protocol data units (PPDUs) with one or more STAs associated with the shared AP during a respective portion of the TXOP allocated to the shared AP. The enhanced variant of MU-RTS TXS frame may carry scheduling times t₁, t₂, . . . by announcing TXOP allocation times to shared APs and may carry additional control information related to AP Identification (ID) addresses or low latency traffic.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5th Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example design under a proposed scheme in accordance with the present disclosure.

FIG. 6 is a diagram of an example scenario under a proposed scheme in accordance with the present disclosure.

FIG. 7 is a block diagram of an example communication system under a proposed scheme in accordance with the present disclosure.

FIG. 8 is a flowchart of an example process under a proposed scheme in accordance with the present disclosure.

FIG. 9 is a flowchart of an example process under a proposed scheme in accordance with the present disclosure.

FIG. 10 is a flowchart of an example process under a proposed scheme in accordance with the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to C-TDMA protocols, TXOP sharing modes for time allocation, and exchange of parameters in multi-AP systems in wireless communications. According to the present disclosure, a number of possible solutions may be implemented separately or jointly. That is, although these possible solutions may be described below separately, two or more of these possible solutions may be implemented in one combination or another.

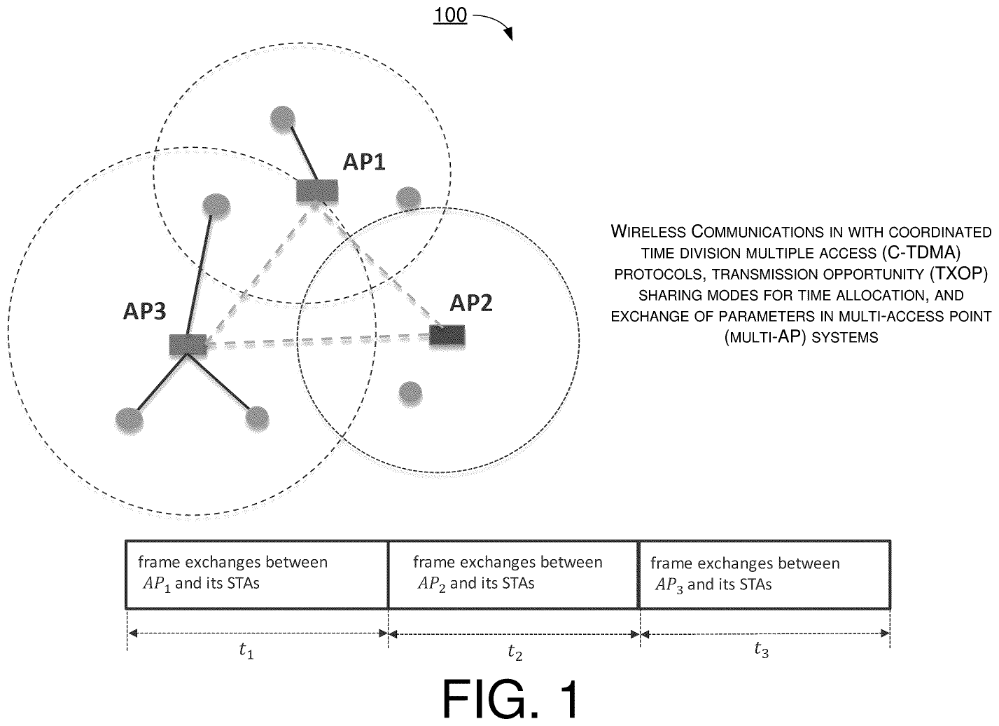

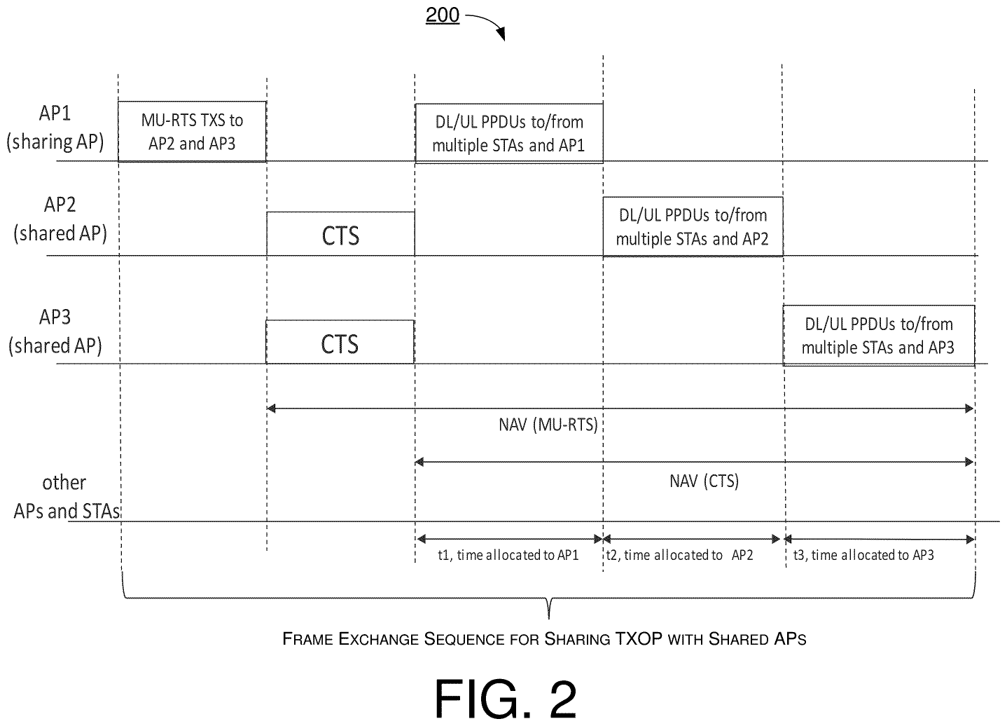

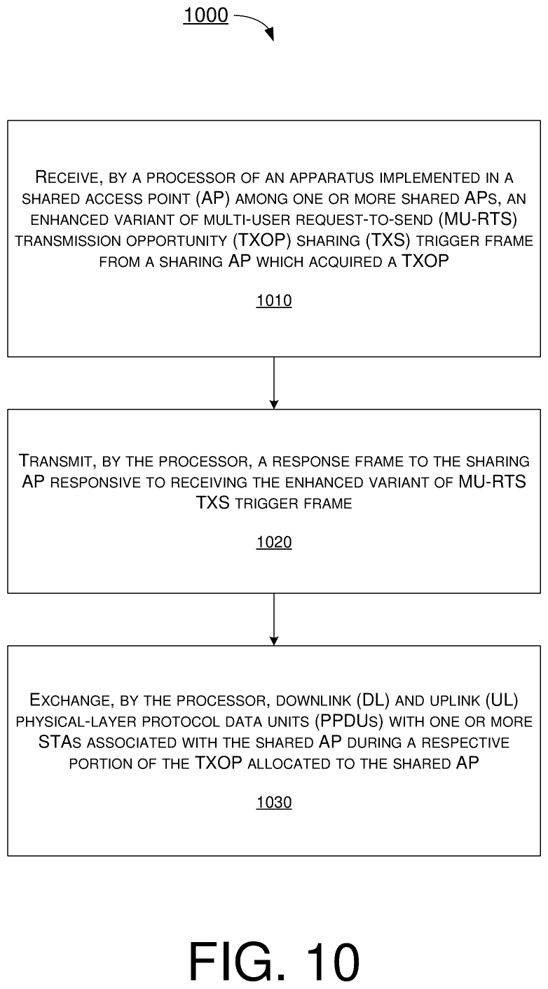

FIG. 1 illustrates an example network environment 100 in which various solutions and schemes in accordance with the present disclosure may be implemented. FIG. 2˜ FIG. 10 illustrate examples of implementation of various proposed schemes in network environment 100 in accordance with the present disclosure. The following description of various proposed schemes is provided with reference to FIG. 1˜ FIG. 10.

Referring to FIG. 1, network environment 100 may involve a multi-AP system with at least a first AP (e.g., AP₁), with its associated STAs, a second AP (AP₂), with its associated STAs, and a third AP (AP₃), with its associated STAs. Each of AP₁, AP₂ and AP₃, as well as their associated STAs, may be configured to communicate with each other by utilizing the C-TDMA protocols, TXOP sharing modes for time allocation, and exchange of parameters in multi-AP systems in accordance with various proposed schemes described below. For instance, under the various proposed schemes described herein, AP₁ may function as a sharing AP, and each of AP₂ and AP₃ may function as a shared AP. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example scenario 200 under a proposed scheme in accordance with the present disclosure. Under the proposed scheme, the framework for C-TDMA protocol for frame exchange may be defined in accordance with the triggered TXOP sharing (TXS) protocol described in the IEEE 802.11 standard. The C-TDMA protocol may be characterized with certain specifics, including: (a) reuse of existing TXS protocol with enhancements in an enhanced variant of multi-user request-to-send (MU-RTS) TXS trigger frame; (b) the enhanced variant of MU-RTS TXS trigger frame carrying control information to shared APs such as TXOP allocated times to shared APs, the AP identification (ID) or address of shared APs, and other low-latency traffic information; (c) the enhanced variant of MU-RTS TXS having two or more User Info fields in its format to support the APs (including the sharing AP and the shared APs); (d) the enhanced variant of MU-RTS TXS being extended with the fields to distinguish from the enhanced variant of MU-RTS TXS trigger frame that supports only non-AP extremely-high throughput (EHT) STAS; (e) the enhanced variant of MU-RTS TXS being extended to support trigger-based (TB) physical-layer protocol data units (PPDUs); (f) the enhanced variant of MU-RTS TXS announcing time allocations to shared APs that are the portions of the TXOP acquired by the sharing AP; and (g) the enhanced variant of MU-RTS TXS with scheduling option that reduces the protocol overhead and allows for flexibility in inter-AP coordination.

Scenario 200 shown in FIG. 2 may pertain to the C-TDMA protocol that describes a sequence of frame exchanges for sharing a TXOP acquired by the sharing AP. The AP that wins the contention for the TXOP becomes the sharing AP, which sends a control frame (e.g., an enhanced variant of the enhanced variant of MU-RTS TXS trigger frame) under the proposed scheme. The enhanced variant of MU-RTS TXS may carry AP IDs of the shared APs with whom the sharing AP intends to share the TXOP. Each of the shared APs addressed in the enhanced variant of MU-RTS TXS may respond with a response frame (e.g., a clear-to-send (CTS) frame). All other non-AP STAs and APs that receive the enhanced variant of MU-RTS TXS and response frames may set their network allocation vectors (NAVs). The enhanced variant of MU-RTS TXS may carry the TXOP allocation times t₁, t₂, . . . assigned to the shared APs and may support multiple User Info fields. The TXOP allocation times may also be distributed to the shared AP using the proposed scheme for sharing PHY/MAC parameters to be described below. Each User Info field of the enhanced variant of MU-RTS TXS trigger frame may contain a specific subfield corresponding to a respective one of the sharing AP and the shared APs. The allocation times may be specified in the allocation subfield of the enhanced variant of MU-RTS TXS trigger frame and may be computed by the sharing AP. FIG. 2 shows that the shared APs and sharing AP may proceed with either uplink (UL) or downlink (DL) transmissions only within the allocated time t₁, t₂, . . . within the TXOP. These transmissions may be single-user (SU), multi-user (MU) or TB-based PPDU transmissions. The frame exchanges within the allocated time durations may be additionally protected using the conventional enhanced variant of MU-RTS/CTS mechanism.

Under the proposed scheme, in C-TDMA, an AP may coordinate with other APs to establish their C-TDMA membership. This may involve configuration setup that requires an AP to perform discovery initiation, negotiation and, if necessary, creation of C-TDMA group(s). The discovery phase may involve finding C-TDMA-capable APs. During the initiation phase, an AP may send a C-TDMA membership request and receive responses from all the APs in a C-TDMA group (that is being formed). Also, during the negotiation phase, an AP may negotiate with other APs participating in the C-TDMA a set of parameters related to bandwidth, TXOP duration, low-latency traffic, and so on. If the negotiation is successful, the involved APs may be granted membership in the C-TDMA group.

Under a proposed scheme in accordance with the present disclosure, a mechanism to address the TXOP sharing issue may be incorporated in the negotiation phase a TXOP sharing mode. With this approach, an AP may negotiate with other APs its requirements by selecting a type of TXOP sharing mode. For instance, an AP may request the resources from other APs in the C-TDMA group by selecting a type of TXOP sharing mode. The decisions as to whether to accept the TXOP sharing mode may be made individually by each AP in the C-TDMA group. If all the APs in the C-TDMA group accept the resource sharing request, the AP may be granted membership in the C-TDMA group. The APs in the group may send a re-negotiation request after a certain period of time. In an event that a C-TDMA membership is not granted, the AP may negotiate again after a predetermined or random period of time.

Under a proposed scheme in accordance with the present disclosure, there may be a number of TXOP sharing modes in which APs participating in C-TDMA may operate. In a first TXOP sharing mode (Type 1) under the proposed scheme, a sharing AP may share the acquired TXOP equally with all the shared APs in a C-TDMA group. The sharing AP may allocate to each AP in the C-TDMA group an interval with a duration of

$$\frac{{TXOP}_{duration}}{N} ,$$

where N denotes the number of APs in the C-TDMA group. For example, given 3 APs in the C-TDMA group, the TXOP may be split equally into 3 portions so that each AP is allocated an equal amount of time that is

$$\frac{{TXOP}_{duration}}{3} ,$$

This mode may be simple to implement but the sharing AP may need to allocate a large portion of resources to shared APs, thereby sacrificing its own performance in terms of throughput and latency. As such, this mode may be suitable for a scenario in which the APs are not loaded much and have little low-latency traffic.

In a second TXOP sharing mode (Type 2) under the proposed scheme, the sharing AP may be constrained in allocating its sharing times of an acquired TXOP within previously negotiated range(s). That is, each AP in the C-TDMA group may negotiate its range of TXOP share, TXOP_{duration}×[Tₘᵢₙ, Tₘₐₓ], during the negotiation phase so that for APᵢ the time t₁ needs to be in the following range:

$${T}_{min , {AP}_{i}} \times {TXOP}_{duration} \leq {t}_{i} \leq {T}_{max , {AP}_{i}} \times {TXOP}_{duration}$$

For example, with 3 APs in the T-CDMA group, the sharing AP may need to allocate t₁, t₂ and t₃ so that these times are within the following ranges:
For AP₁, Tₘᵢₙ, AP₁×TXOP_{duration}≤t₁≤Tₘₐₓ, AP₁×TXOP_{duration};
For AP₂, Tₘᵢₙ, AP₂×TXOP_{duration}≤t₂≤Tₘₐₓ, AP₂×TXOP_{duration}; and
For AP₃, Tₘᵢₙ, AP₃×TXOP_{duration}≤t₃≤Tₘₐₓ, AP₃×TXOP duration.

Moreover, the allocated times need to meet the requirement of (t₁+t₂+t₃)≤ TXOP_{duration}.

When in this second TXOP sharing mode, the ranges may be selected by an AP using one of two options. In option (a), an AP may be free to choose any number from [O, TXOP_{duration}]. In option (b), an AP may select from the set of predefined ranges of {[0.1, 0.9], [0.2, 0.8], . . . [0.9, 0.1]}. In the second TXOP sharing mode, if the offered range is rejected by APs in the C-TDMA group, the protocol may offer additional rounds of resource request with new values. Alternatively, or additionally, an AP may start a new round of negotiation after a certain time elapses.

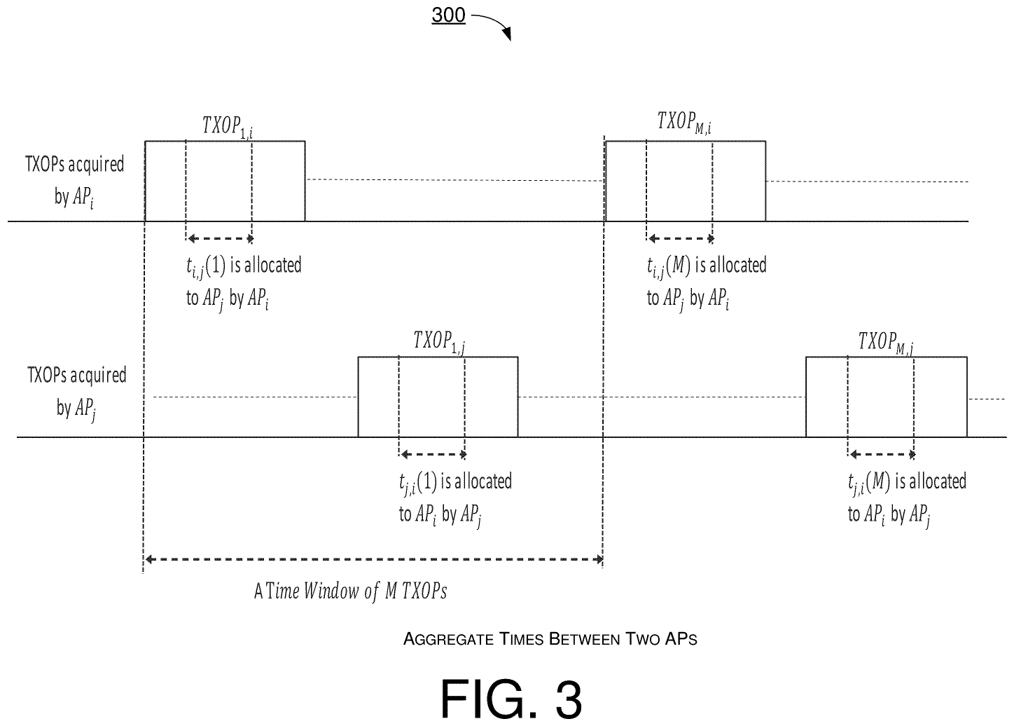

In a third TXOP sharing mode (Type 3) under the proposed scheme, a sharing AP may be required to maintain an aggregate equal-time rule between any pair of two APs. FIG. 3 illustrates an example scenario 300 under the third TXOP sharing mode under the proposed scheme. In this mode, the aggregate allocation time Tᵢⱼ may be referred to as the “total time” that was allocated by APᵢ to APⱼ over a number of M previous TXOPs (e.g., T_{i,j}=Σₖ₌₁, . . . ,_{M} t_{i,j}(k), where t_{i,j}(k) denotes the amount of time allocated in the kth TXOP by APᵢ to APⱼ). This mode may require APᵢ to hold the equal-time rule of T_{i,j}=T_{j,i}. That is, after M TXOPs, APᵢ needs to allocate to APⱼ the equivalent of amount of time that APᵢ has received from APⱼ.

This third TXOP sharing mode may be held between any pairs of APs from the C-TDMA group. The main advantage of this mode is flexibility as the sharing AP is not constrained by any rule in allocating times for each acquired TXOP as long as the aggregate equal time rule is maintained by the sharing AP over M TXOPs. As such, this mode may be suitable for a scenario in which APs in the C-TDMA group experience bursty low-latency traffic.

In a fourth TXOP sharing mode (Type 4) under the proposed scheme, a sharing AP may find the allocation times t₁, t₂, . . . by the following computation:

$${t}_{i} = \frac{{N}_{i}}{{\sum }_{i = 1 , … , L} {N}_{i}} {TXOP}_{duration}$$

for all i=1, . . . , L, where L denotes the number of APs in a C-TDMA group and Nᵢ denotes the number of STAs with queued low latency traffic being served by APᵢ. The sharing AP may collect information on the number of active STAs with low-latency traffic, N₁, . . . . N_{L}, served by each of the shared APs before computing the TXOP sharing times. The collection of information on the number of STAs may be accomplished by using the proposed scheme described below or during the C-TDMA phase. Whenever the number of supported/served changes, the affected AP may need to update other APs participating in C-TDMA with a new number of STAs it serves. Accordingly, this mode may be computationally fast and simple, may need only a minimal number of parameters from shared APs, and this mode may be flexible in providing fairness.

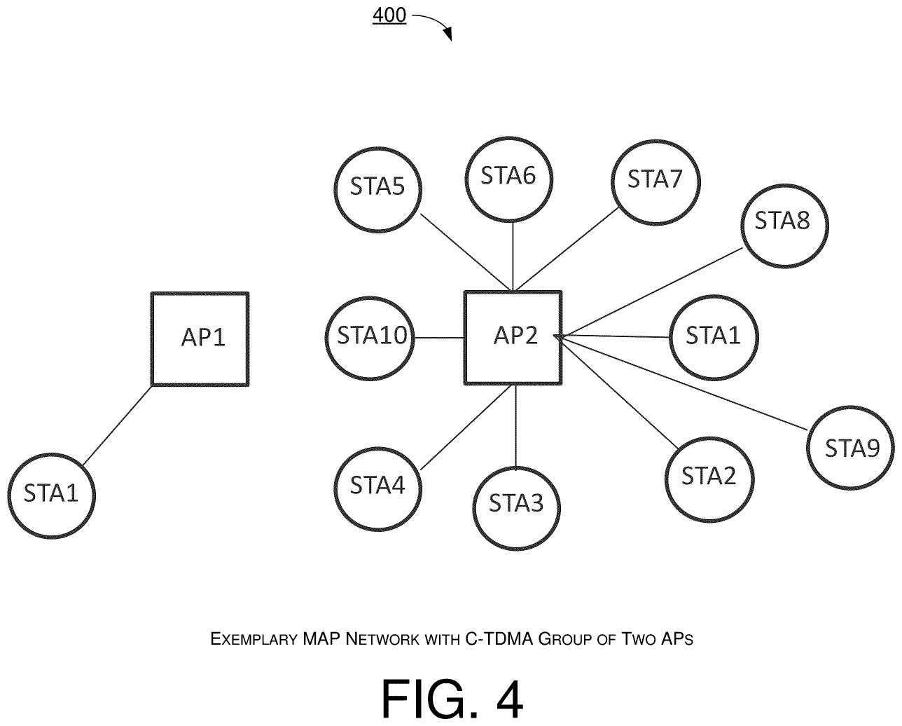

FIG. 4 illustrates an example scenario 400 under the fourth TXOP sharing mode under the proposed scheme. Under this mode, the STA fairness may be provided by allocating TXOP times proportionally to the number of STAs being served by each participating AP. Referring to FIG. 4, in which an exemplary MAP network is enabled with the fourth TXOP sharing mode. Without C-TDMA, AP1 and AP2 may have somewhat equal access probability to the channel while serving very different numbers of STAs. This means STA1 associated with AP1 may have a higher access rate than the STAs associated with AP2. For instance, STA1 associated with AP1 may have an access rate of 0.5 while STA1˜ STA10 associated with AP2 may have an access rate of 0.05. Under the proposed scheme, C-TDMA may provide per-STA fairness by allocating

$${t}_{1} = \frac{1}{11} {TXOP}_{duration}$$

### to AP1 and

$${t}_{2} = \frac{10}{11} {TXOP}_{duration}$$

### to AP2.

It is noteworthy that, when APs operate in any TXOP mode under the proposed schemes described herein, an AP may send a request to other APs asking for more resources. When the request is approved by an AP in the C-TDMA group, that AP may allocate more resources in future TXOPs to the requesting AP. If the request is denied by another AP, the requesting AP may try again after a certain period of time.

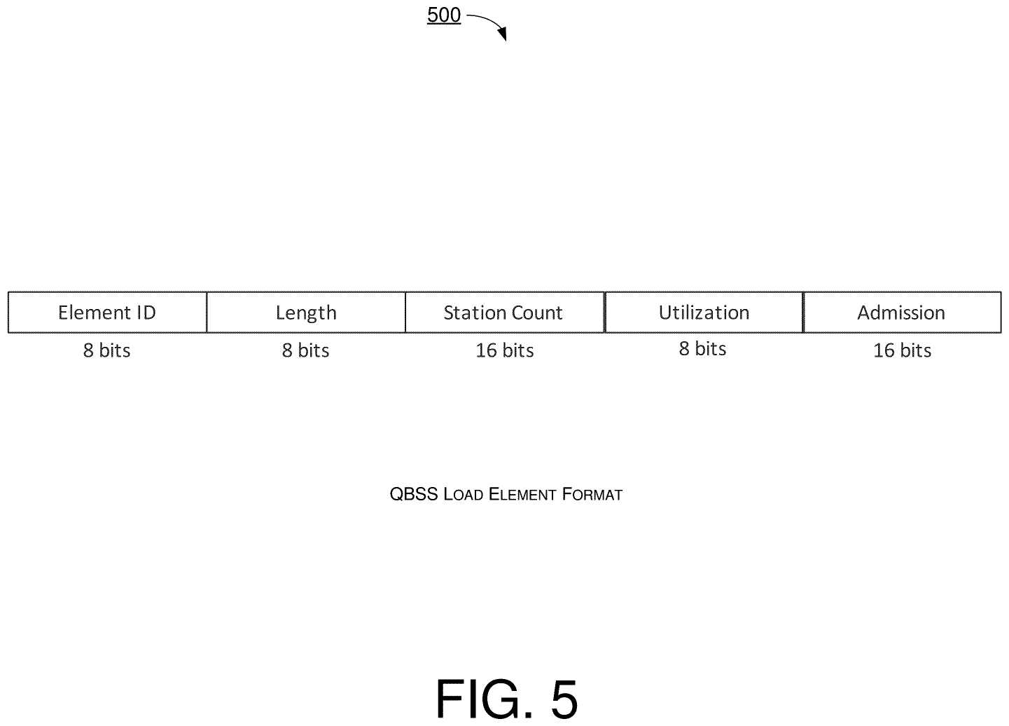

FIG. 5 illustrates an example design 500 under a proposed scheme in accordance with the present disclosure. Under the proposed scheme, beacons may be employed in exchange and sharing of PHY/MAC parameters. This may reduce protocol overhead by exploiting the broadcast property of beacons. The parameter that may be broadcasted by APs in beacons may include: (a) in CSR, received signal strength indicator (RSSI) values to estimate channel path losses between APs and STAs; and (b) in C-TDMA, the number of STAs N₁, . . . . N_{L} served by each of the shared APs. This proposed scheme adopts the quality of service (QOS) enhanced basic service set (QBSS) information element (IE), which may be advertised in every beacon by APs. An example QBSS load element format under the proposed scheme is shown in FIG. 5.

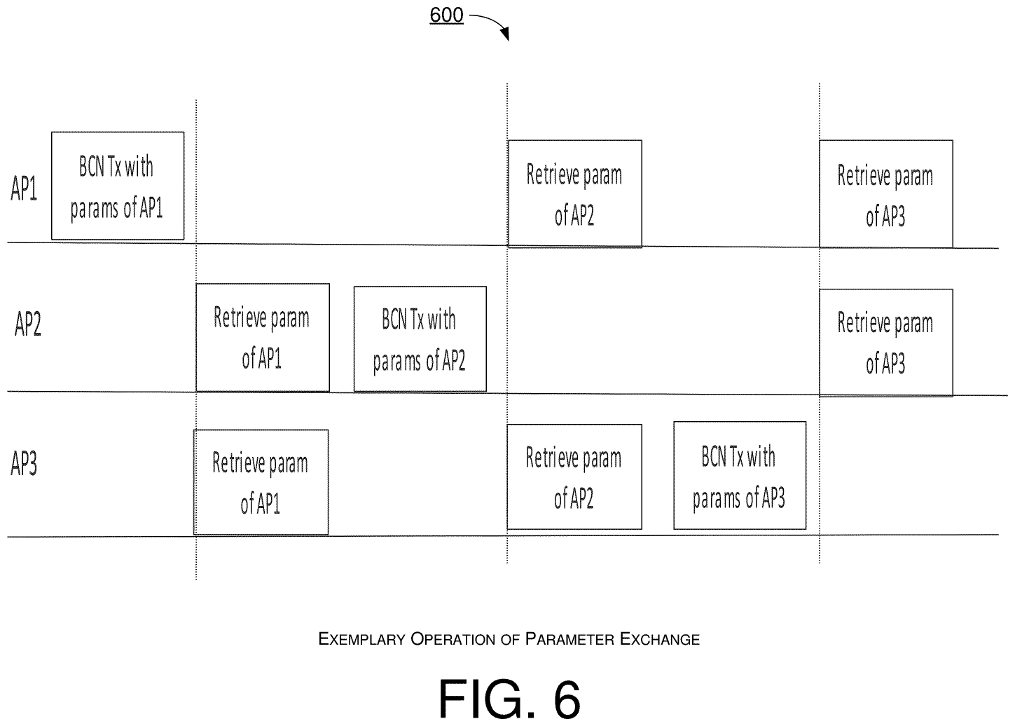

FIG. 6 illustrates an example scenario 600 under a proposed scheme in accordance with the present disclosure. Under the proposed scheme, for CSR, the admission field of the QBSS IE may be used for parameter exchange between the APs. The parameter value may represent the 256 levels of RSSI value between an AP and a STA with index ID carried in the utilization field of the QBSS IE. Each beacon may carry only one RSSI measurement value between an AP and a STA. It may be assumed that an AP may estimate the RSSI value from management frames received from the STA using the legacy PHY preamble. The RSSI values for other STAs may be sent in subsequent beacons. Under the proposed scheme, for C-TDMA, the parameter value carried in the admission field of the QBSS IE may represent the number of STAs being supported by the AP. Referring to FIG. 6, for an example of 3-AP coordination when APs exchange parameters with other APs, beacons may carry parameters that are retrieved by other APs. In FIG. 6, “BCN” denotes a beacon.

### Illustrative Implementations

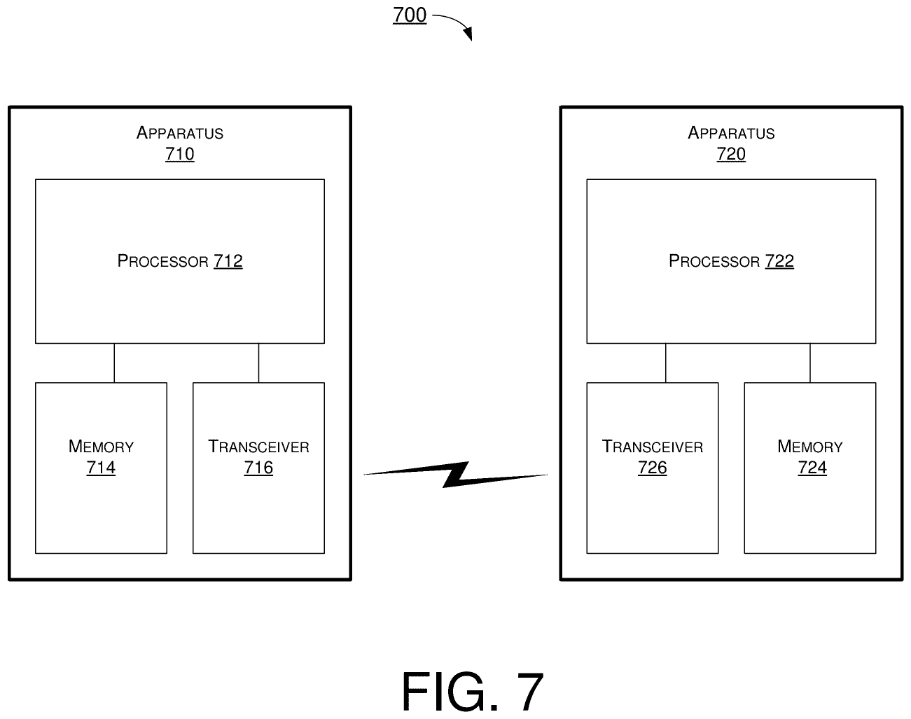

FIG. 7 illustrates an example system 700 having at least an example apparatus 710 and an example apparatus 720 in accordance with an implementation of the present disclosure. Each of apparatus 710 and apparatus 720 may perform various functions to implement schemes, techniques, processes and methods described herein pertaining to C-TDMA protocols, TXOP sharing modes for time allocation, and exchange of parameters in multi-AP systems in wireless communications, including the various schemes described above with respect to various proposed designs, concepts, schemes, systems and methods described above as well as processes described below. For instance, apparatus 710 may be an example implementation of a sharing AP (e.g., AP₁), and apparatus 720 may be an example implementation of a shared AP (e.g., AP₂ or AP₃).

Each of apparatus 710 and apparatus 720 may be a part of an electronic apparatus, such as a portable or mobile apparatus, a wearable apparatus, a wireless communication apparatus or a computing apparatus. For instance, each of apparatus 710 and apparatus 720 may be implemented in a smartphone, a smart watch, a personal digital assistant, a digital camera, or a computing equipment such as a tablet computer, a laptop computer or a notebook computer. Each of apparatus 710 and apparatus 720 may also be a part of a machine type apparatus, which may be an IoT apparatus such as an immobile or a stationary apparatus, a home apparatus, a wire communication apparatus or a computing apparatus. For instance, each of apparatus 710 and apparatus 720 may be implemented in a smart thermostat, a smart fridge, a smart door lock, a wireless speaker or a home control center. When implemented in or as a network apparatus, apparatus 710 and/or apparatus 720 may be implemented in a network node, such as an AP in a WLAN.

In some implementations, each of apparatus 710 and apparatus 720 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 710 and apparatus 720 may be implemented in or as a STA or an AP. Each of apparatus 710 and apparatus 720 may include at least some of those components shown in FIG. 7 such as a processor 712 and a processor 722, respectively, for example. Each of apparatus 710 and apparatus 720 may further include one or more other components not pertinent to the proposed scheme of the present disclosure (e.g., internal power supply, display device and/or user interface device), and, thus, such component(s) of apparatus 710 and apparatus 720 are neither shown in FIG. 7 nor described below in the interest of simplicity and brevity.

In one aspect, each of processor 712 and processor 722 may be implemented in the form of one or more single-core processors, one or more multi-core processors, one or more RISC processors or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks including those pertaining to C-TDMA protocols, TXOP sharing modes for time allocation, and exchange of parameters in multi-AP systems in wireless communications in accordance with various implementations of the present disclosure. For instance, each of processor 712 and processor 722 may be configured with hardware components, or circuitry, implementing one, some or all of the examples described and illustrated herein.

In some implementations, apparatus 710 may also include a transceiver 716 coupled to processor 712. Transceiver 716 may be capable of wirelessly transmitting and receiving data. In some implementations, apparatus 720 may also include a transceiver 726 coupled to processor 722. Transceiver 726 may include a transceiver capable of wirelessly transmitting and receiving data.

In some implementations, apparatus 710 may further include a memory 714 coupled to processor 712 and capable of being accessed by processor 712 and storing data therein. In some implementations, apparatus 720 may further include a memory 724 coupled to processor 722 and capable of being accessed by processor 722 and storing data therein. Each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

Each of apparatus 710 and apparatus 720 may be a communication entity capable of communicating with each other using various proposed schemes in accordance with the present disclosure. For illustrative purposes and without limitation, a description of capabilities of apparatus 710, as a sharing AP (e.g., AP₁), and apparatus 720, as a shared AP (e.g., AP₂ or AP₃), is provided below in the context of example processes 800, 900 and 1000. It is noteworthy that, although the example implementations described below are provided in the context of WLAN, the same may be implemented in other types of networks. Thus, although the following description of example implementations pertains to a scenario in which apparatus 710 functions as a transmitting device and apparatus 720 functions as a receiving device, the same is also applicable to another scenario in which apparatus 710 functions as a receiving device and apparatus 720 functions as a transmitting device.

### Illustrative Processes

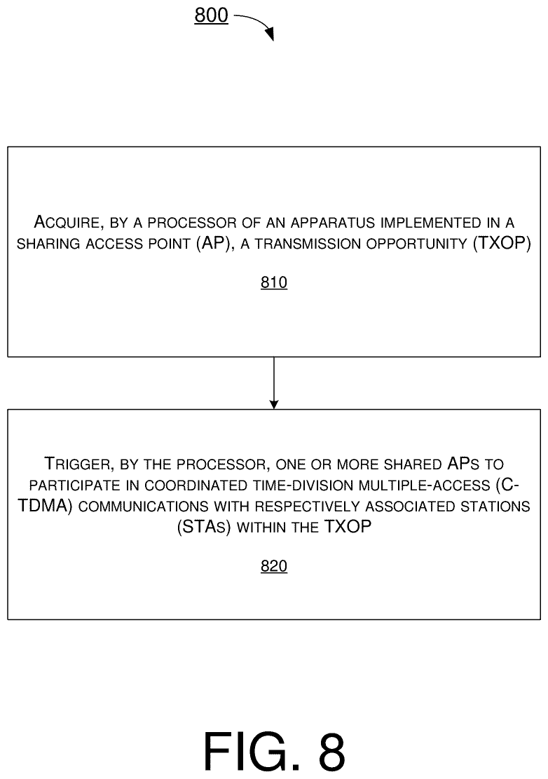

FIG. 8 illustrates an example process 800 in accordance with an implementation of the present disclosure. Process 800 may represent an aspect of implementing various proposed designs, concepts, schemes, systems and methods described above. More specifically, process 800 may represent an aspect of the proposed concepts and schemes pertaining to C-TDMA protocols, TXOP sharing modes for time allocation, and exchange of parameters in multi-AP systems in wireless communications in accordance with the present disclosure. Process 800 may include one or more operations, actions, or functions as illustrated by one or more of blocks 810 and 820. Although illustrated as discrete blocks, various blocks of process 800 may be divided into additional blocks, combined into fewer blocks, or eliminated, depending on the desired implementation. Moreover, the blocks/sub-blocks of process 800 may be executed in the order shown in FIG. 8 or, alternatively, in a different order. Furthermore, one or more of the blocks/sub-blocks of process 800 may be executed repeatedly or iteratively. Process 800 may be implemented by or in apparatus 710 and apparatus 720 as well as any variations thereof. Solely for illustrative purposes and without limiting the scope, process 800 is described below in the context of apparatus 710 as a sharing AP (e.g., AP₁) and apparatus 720 as a shared AP (e.g., AP₂ or AP₃) of a wireless network such as a multi-AP system in a WLAN in accordance with one or more of IEEE 802.11 standards. Process 800 may begin at block 810.

At 810, process 800 may involve processor 712 of apparatus 710 acquiring, via transceiver 716, a TXOP. Process 800 may proceed from 810 to 820.

At 820, process 800 may involve processor 712 triggering, via transceiver 716, one or more shared APs (including apparatus 720) to participate in C-TDMA communications with respectively associated STAs within the TXOP.

In some implementations, in triggering, process 800 may involve processor 712 performing certain operations. For instance, process 800 may involve processor 712 transmitting an enhanced variant of MU-RTS TXS trigger frame to the one or more shared APs. Additionally, process 800 may involve processor 712 receiving a respective response frame (e.g., a CTS frame) from each of the one or more shared APs responsive to transmitting the enhanced variant of MU-RTS TXS trigger frame. Moreover, process 800 may involve processor 712 exchanging DL and UL PPDUs with one or more STAs associated with the sharing AP during a respective portion of the TXOP allocated to the sharing AP.

In some implementations, the enhanced variant of MU-RTS TXS trigger frame, functioning as an announcement frame, may contain information on a respective TXOP allocation time for each of the one or more shared APs, an AP ID of each of the one or more shared APs, and low-latency traffic information. Moreover, each of the one or more shared APs may communicate with respective one or more STAs associated with the respective shared AP during the respective TXOP allocation time.

In some implementations, the enhanced variant of MU-RTS TXS trigger frame may include two or more User Info fields corresponding to the one or more shared APs and the sharing AP. In such cases, each of the one or more User Info fields may contain a specific subfield corresponding to a respective one of the one or more shared APs and the sharing AP.

In some implementations, prior to the triggering, process 800 may involve processor 712 performing additional operations. For instance, process 800 may involve processor 712 discovering, via transceiver 716, at least one C-TDMA-capable AP during a discovery phase. Also, process 800 may involve processor 712 requesting, via transceiver 716, the at least one C-TDMA-capable AP to form a C-TDMA group during an initiation phase. Moreover, process 800 may involve processor 712 negotiating, via transceiver 716, with one or more APs among the at least one C-TDMA-capable AP that responded positively to the requesting regarding a set of parameters during a negotiation phase. Furthermore, process 800 may involve processor 712 creating the C-TDMA group with the one or more APs, as the one or more shared APs, upon a successful completion of the negotiation phase.

In some implementations, the set of parameters may be related to a bandwidth, a TXOP duration, and a low-latency traffic.

In some implementations, in negotiating, process 800 may further involve processor 712 selecting one of a plurality of TXOP sharing modes used by all APs in the C-TDMA group in sharing the TXOP. In some implementations, the plurality of TXOP sharing modes may include: (1) a first TXOP sharing mode requiring the sharing AP to share the TXOP equally among all the APs in the C-TDMA group; (2) a second TXOP sharing mode requiring the sharing AP to allocate sharing times of the TXOP to All the APs in the C-TDMA group within previously negotiated ranges such that, for APᵢ, a respective TXOP allocation time is in a range of Tₘᵢₙ, APᵢ×a duration of TXOP≤tᵢ≤Tₘₐₓ, APᵢ×the duration of TXOP, and that Σtᵢ≤the duration of TXOP, with Tₘᵢₙ, APᵢ and Tₘₐₓ, APᵢ denoting a minimum sharing time and a maximum sharing time with respect to APᵢ, and with tᵢ denoting a respective TXOP allocation time for APᵢ, (3) a third TXOP sharing mode requiring the sharing AP to maintain an aggregate equal-time rule between any pair of two APs of all the APs in the C-TDMA group such that T_{i,j}=T_{j,i}, with T_{i,j} and T_{j,i} denoting a total amount of time allocated by AP; to AP, and a total amount of time allocated by APⱼ to APᵢ, respectively, after a number M of TXOPs, and with M being a positive integer; and (4) a fourth TXOP sharing mode requiring the sharing AP to compute allocation times t1, t2, . . . by computing tᵢ=Ni/(Σᵢ₌₁, . . . ._{L} Nᵢ)*the duration of TXOP for all i=1, . . . , L, with L being a number of APs in the C-TDMA group and Nᵢ denoting a number of STAs being served by APᵢ.

In some implementations, process 800 may involve processor 712 performing additional operations. For instance, process 800 may involve processor 712 transmitting, via transceiver 716, a beacon. Moreover, process 800 may involve processor 712 receiving, via transceiver 716, a respective beacon from each of the one or more shared APs. Each of the transmitted and received beacons may contain one or more parameters.

In some implementations, the one or more parameters may include: (a) a RSSI regarding a channel path loss between the sharing AP or one of the one or more shared APs and a respectively associated STA for CSR; and/or (b) a number of STAs served by the sharing AP or one of the one or more shared APs for C-TDMA.

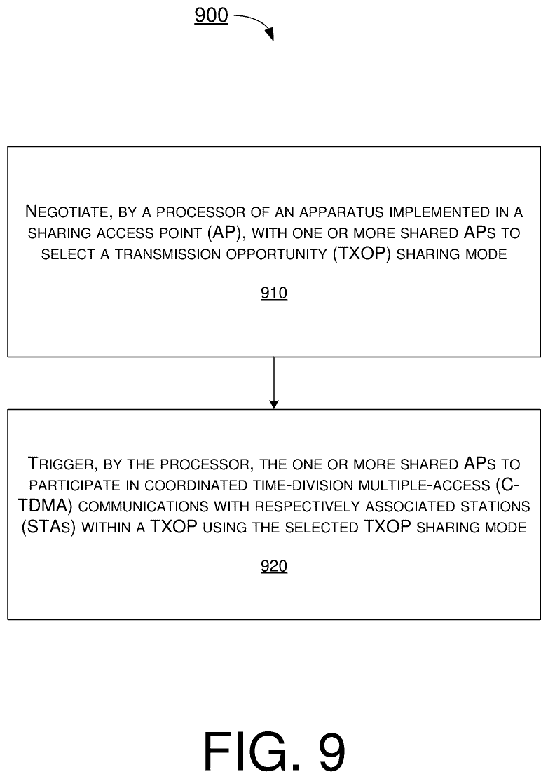

FIG. 9 illustrates an example process 900 in accordance with an implementation of the present disclosure. Process 900 may represent an aspect of implementing various proposed designs, concepts, schemes, systems and methods described above. More specifically, process 900 may represent an aspect of the proposed concepts and schemes pertaining to C-TDMA protocols, TXOP sharing modes for time allocation, and exchange of parameters in multi-AP systems in wireless communications in accordance with the present disclosure. Process 900 may include one or more operations, actions, or functions as illustrated by one or more of blocks 910 and 920. Although illustrated as discrete blocks, various blocks of process 900 may be divided into additional blocks, combined into fewer blocks, or eliminated, depending on the desired implementation. Moreover, the blocks/sub-blocks of process 900 may be executed in the order shown in FIG. 9 or, alternatively, in a different order. Furthermore, one or more of the blocks/sub-blocks of process 900 may be executed repeatedly or iteratively. Process 900 may be implemented by or in apparatus 710 and apparatus 720 as well as any variations thereof. Solely for illustrative purposes and without limiting the scope, process 900 is described below in the context of apparatus 710 as a sharing AP (e.g., AP₁) and apparatus 720 as a shared AP (e.g., AP₂ or AP₃) of a wireless network such as a multi-AP system in a WLAN in accordance with one or more of IEEE 802.11 standards. Process 900 may begin at block 910.

At 910, process 900 may involve processor 712 of apparatus 710 negotiating, via transceiver 716, with one or more shared APs (including apparatus 720) to select a TXOP sharing mode. Process 900 may proceed from 910 to 920.

At 920, process 900 may involve processor 712 triggering, via transceiver 716, the one or more shared APs to participate in C-TDMA communications with respectively associated STAs within a TXOP using the selected TXOP sharing mode.

In some implementations, the selected TXOP sharing mode may require the sharing AP to share the TXOP equally among all the APs in the C-TDMA group.

Alternatively, the selected TXOP sharing mode may require the sharing AP to allocate sharing times of the TXOP to All the APs in the C-TDMA group within previously negotiated ranges such that, for APᵢ, a respective TXOP allocation time is in a range of Tₘᵢₙ, AP₁×a duration of TXOP≤tᵢ≤Tₘₐₓ, APᵢ×the duration of TXOP, and that Σtᵢ≤the duration of TXOP, with Tₘᵢₙ, APᵢ and Tₘₐₓ, APᵢ denoting a minimum sharing time and a maximum sharing time with respect to APᵢ, and with tᵢ denoting a respective TXOP allocation time for APᵢ.

Alternatively, the selected TXOP sharing mode may require the sharing AP to maintain an aggregate equal-time rule between any pair of two APs of all the APs in the C-TDMA group such that T_{i,j}=T_{j,i}, with T_{i,j} and T_{j,i}, denoting a total amount of time allocated by APᵢ to APⱼ and a total amount of time allocated by APⱼ to APᵢ, respectively, after a number M of TXOPs, and with M being a positive integer.

Alternatively, the selected TXOP sharing mode may require the sharing AP to compute allocation times t1, t2, . . . by computing t; =Ni/(Σᵢ₌₁, . . . . L Nᵢ)*a duration of TXOP for all i=1, . . . , L, with L being a number of APs in the C-TDMA group and Nᵢ denoting a number of STAs being served by APᵢ.

FIG. 10 illustrates an example process 1000 in accordance with an implementation of the present disclosure. Process 1000 may represent an aspect of implementing various proposed designs, concepts, schemes, systems and methods described above. More specifically, process 1000 may represent an aspect of the proposed concepts and schemes pertaining to C-TDMA protocols, TXOP sharing modes for time allocation, and exchange of parameters in multi-AP systems in wireless communications in accordance with the present disclosure. Process 1000 may include one or more operations, actions, or functions as illustrated by one or more of blocks 1010, 1020 and 1030. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively, in a different order. Furthermore, one or more of the blocks/sub-blocks of process 1000 may be executed repeatedly or iteratively. Process 1000 may be implemented by or in apparatus 710 and apparatus 720 as well as any variations thereof. Solely for illustrative purposes and without limiting the scope, process 1000 is described below in the context of apparatus 710 as a sharing AP (e.g., AP₁) and apparatus 720 as a shared AP (e.g., AP₂ or AP₃) of a wireless network such as a multi-AP system in a WLAN in accordance with one or more of IEEE 802.11 standards. Process 1000 may begin at block 1010.

At 1010, process 1000 may involve processor 722 of apparatus 720 receiving, via transceiver 726, an enhanced variant of MU-RTS TXS trigger frame from apparatus 710, as a sharing AP, which acquired a TXOP. Process 1000 may proceed from 1010 to 1020.

At 1020, process 1000 may involve processor 722 transmitting, via transceiver 726, a response frame to the sharing AP responsive to receiving the enhanced variant of MU-RTS TXS trigger frame. Process 1000 may proceed from 1020 to 1030.

At 1030, process 1000 may involve processor 722 exchanging, via transceiver 726, DL and UL PPDUs with one or more STAs associated with the shared AP during a respective portion of the TXOP allocated to the shared AP.

In some implementations, the enhanced variant of MU-RTS TXS trigger frame, functioning as an announcement frame, may contain information on a respective TXOP allocation time for each of the one or more shared APs, an AP ID of each of the one or more shared APs, and low-latency traffic information. Moreover, each of the one or more shared APs may communicate with respective one or more STAs associated with the respective shared AP during the respective TXOP allocation time.

In some implementations, the enhanced variant of MU-RTS TXS trigger frame may include two or more User Info fields corresponding to the one or more shared APs and the sharing AP. In such cases, each of the one or more User Info fields may contain a specific subfield corresponding to a respective one of the one or more shared APs and the sharing AP. Moreover, the enhanced variant of MU-RTS TXS trigger frame may be extended to support SU, MU and TB PPDUs.

In some implementations, process 1000 may further involve processor 722 negotiating, via transceiver 726, with the sharing AP to select one of a plurality of TXOP sharing modes used by all APs in a C-TDMA group in sharing the TXOP.

In some implementations, the plurality of TXOP sharing modes may include: (1) a first TXOP sharing mode requiring the sharing AP to share the TXOP equally among all the APs in the C-TDMA group; (2) a second TXOP sharing mode requiring the sharing AP to allocate sharing times of the TXOP to All the APs in the C-TDMA group within previously negotiated ranges such that, for APᵢ, a respective TXOP allocation time is in a range of Tₘᵢₙ, APᵢ×a duration of TXOP≤tᵢ≤Tₘₐₓ, APᵢ×the duration of TXOP, and that Σtᵢ≤the duration of TXOP, with Tₘᵢₙ, APᵢ and Tₘₐₓ, APᵢ denoting a minimum sharing time and a maximum sharing time with respect to APᵢ, and with tᵢ denoting a respective TXOP allocation time for APᵢ; (3) a third TXOP sharing mode requiring the sharing AP to maintain an aggregate equal-time rule between any pair of two APs of all the APs in the C-TDMA group such that T_{i,j}=T_{j,i}, with T_{i,j} and T_{j,i} denoting a total amount of time allocated by AP to APⱼ and a total amount of time allocated by APⱼ to APᵢ, respectively, after a number M of TXOPs, and with M being a positive integer; and (4) a fourth TXOP sharing mode requiring the sharing AP to compute allocation times t1, t2, . . . by computing tᵢ=Ni/(Σᵢ₌₁ . . . ._{L} Nᵢ)*the duration of TXOP for all i=1, . . . , L, with L being a number of APs in the C-TDMA group and Nᵢ denoting a number of STAs being served by APᵢ.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
acquiring, by a processor of an apparatus implemented in a sharing access point (AP), a transmission opportunity (TXOP); and
triggering, by the processor, one or more shared APs to participate in coordinated time-division multiple-access (C-TDMA) communications with respectively associated stations (STAs) within the TXOP.

2. The method of claim 1, wherein the triggering comprises:
transmitting an enhanced variant of] multi-user request-to-send (MU-RTS) TXOP sharing (TXS) trigger frame to the one or more shared APs;
receiving a respective response frame from each of the one or more shared APs responsive to transmitting the enhanced variant of MU-RTS TXS trigger frame; and
exchanging downlink (DL) and uplink (UL) physical-layer protocol data units (PPDUs) with one or more STAs associated with the sharing AP during a respective portion of the TXOP allocated to the sharing AP.

3. The method of claim 2, wherein the enhanced variant of MU-RTS TXS trigger frame, functioning as an announcement frame, contains information on a respective TXOP allocation time for each of the one or more shared APs, an AP identification (ID) of each of the one or more shared APs, and low-latency traffic information, and wherein each of the one or more shared APs communicates with respective one or more STAs associated with the respective shared AP during the respective TXOP allocation time.

4. The method of claim 2, wherein the enhanced variant of MU-RTS TXS trigger frame comprises two or more User Info fields corresponding to the one or more shared APs and the sharing AP, wherein each of the one or more User Info fields contains a specific subfield corresponding to a respective one of the one or more shared APs and the sharing AP.

5. The method of claim 1, prior to the triggering, further comprising:
discovering, by the processor, at least one C-TDMA-capable AP during a discovery phase;
requesting, by the processor, the at least one C-TDMA-capable AP to form a C-TDMA group during an initiation phase;
negotiating, by the processor, with one or more APs among the at least one C-TDMA-capable AP that responded positively to the requesting regarding a set of parameters during a negotiation phase; and
creating, by the processor, the C-TDMA group with the one or more APs, as the one or more shared APs, upon a successful completion of the negotiation phase.

6. The method of claim 5, wherein the set of parameters are related to a bandwidth, a TXOP duration, and a low-latency traffic.

7. The method of claim 5, wherein the negotiating further comprises selecting one of a plurality of TXOP sharing modes used by all APs in the C-TDMA group in sharing the TXOP.

8. The method of claim 7, wherein the plurality of TXOP sharing modes comprise:
a first TXOP sharing mode requiring the sharing AP to share the TXOP equally among all the APs in the C-TDMA group;
a second TXOP sharing mode requiring the sharing AP to allocate sharing times of the TXOP to All the APs in the C-TDMA group within previously negotiated ranges such that, for APᵢ, a respective TXOP allocation time is in a range of Tₘᵢₙ, APᵢ×a duration of TXOP≤tᵢ≤Tₘₐₓ, APᵢ×the duration of TXOP, and that Σtᵢ≤the duration of TXOP, with Tₘᵢₙ, APᵢ and Tₘₐₓ, APᵢ denoting a minimum sharing time and a maximum sharing time with respect to APᵢ, and with tᵢ denoting a respective TXOP allocation time for APᵢ;
a third TXOP sharing mode requiring the sharing AP to maintain an aggregate equal-time rule between any pair of two APs of all the APs in the C-TDMA group such that T_{i,j}=T_{j,i}, with T_{i,j} and T_{j,i} denoting a total amount of time allocated by APᵢ to APⱼ and a total amount of time allocated by APⱼ to APᵢ, respectively, after a number M of TXOPs, and with M being a positive integer; and
a fourth TXOP sharing mode requiring the sharing AP to compute allocation times t1, t2, . . . by computing tᵢ=Ni/(Σᵢ₌₁ . . . _{L} Nᵢ)*the duration of TXOP for all i=1, . . . , L, with L being a number of APs in the C-TDMA group and Nᵢ denoting a number of STAs being served by APᵢ.

9. The method of claim 1, further comprising:
transmitting, by the processor, a beacon; and
receiving, by the processor, a respective beacon from each of the one or more shared APs,
wherein each of the transmitted and received beacons contains one or more parameters.

10. The method of claim 9, wherein the one or more parameters comprise:
a received signal strength indicator (RSSI) regarding a channel path loss between the sharing AP or one of the one or more shared APs and a respectively associated STA for coordinated spatial reuse (CSR); and
a number of STAs served by the sharing AP or one of the one or more shared APs for C-TDMA.

11. A method, comprising:
negotiating, by a processor of an apparatus implemented in a sharing access point (AP), with one or more shared APs to select a transmission opportunity (TXOP) sharing mode; and
triggering, by the processor, the one or more shared APs to participate in coordinated time-division multiple-access (C-TDMA) communications with respectively associated stations (STAs) within a TXOP using the selected TXOP sharing mode.

12. The method of claim 11, wherein the selected TXOP sharing mode requires the sharing AP to share the TXOP equally among all the APs in the C-TDMA group.

13. The method of claim 11, wherein the selected TXOP sharing mode requires the sharing AP to allocate sharing times of the TXOP to All the APs in the C-TDMA group within previously negotiated ranges such that, for APᵢ, a respective TXOP allocation time is in a range of Tₘᵢₙ, APᵢ×a duration of TXOP≤tᵢ≤Tₘₐₓ, APᵢ×the duration of TXOP, and that Σtᵢ≤the duration of TXOP, with Tₘᵢₙ, APᵢ and Tₘₐₓ, APᵢ denoting a minimum sharing time and a maximum sharing time with respect to APᵢ, and with tᵢ denoting a respective TXOP allocation time for APᵢ.

14. The method of claim 11, wherein the selected TXOP sharing mode requires the sharing AP to maintain an aggregate equal-time rule between any pair of two APs of all the APs in the C-TDMA group such that T_{i,j}=T_{j,l}, with T_{i,j} and T_{j,i} denoting a total amount of time allocated by APᵢ to APⱼ and a total amount of time allocated by APⱼ to APᵢ, respectively, after a number M of TXOPs, and with M being a positive integer.

15. The method of claim 11, wherein the selected TXOP sharing mode requires the sharing AP to compute allocation times t1, t2, . . . by computing tᵢ=Ni/(Σᵢ₌₁ . . . _{L} Nᵢ)*a duration of TXOP for all i=1, . . . , L, with L being a number of APs in the C-TDMA group and Ni denoting a number of STAs being served by APᵢ.

16. A method, comprising:
receiving, by a processor of an apparatus implemented in a shared access point (AP) among one or more shared APs, an enhanced variant of multi-user request-to-send (MU-RTS) transmission opportunity (TXOP) sharing (TXS) trigger frame from a sharing AP which acquired a TXOP;
transmitting, by the processor, a response frame to the sharing AP responsive to receiving the enhanced variant of MU-RTS TXS trigger frame; and
exchanging, by the processor, downlink (DL) and uplink (UL) physical-layer protocol data units (PPDUs) with one or more STAs associated with the shared AP during a respective portion of the TXOP allocated to the shared AP.

17. The method of claim 16, wherein the enhanced variant of MU-RTS TXS trigger frame, functioning as an announcement frame, contains information on a respective TXOP allocation time for each of the one or more shared APs, an AP identification (ID) of each of the one or more shared APs, and low-latency traffic information, and wherein each of the one or more shared APs communicates with respective one or more STAs associated with the respective shared AP during the respective TXOP allocation time.

18. The method of claim 16, wherein the enhanced variant of MU-RTS TXS trigger frame comprises two or more User Info fields corresponding to the one or more shared APs and the sharing AP, wherein each of the one or more User Info fields contains a specific subfield corresponding to a respective one of the one or more shared APs and the sharing AP, and wherein the enhanced variant of MU-RTS TXS trigger frame is extended to support single-user (SU), multi-user (MU) and trigger-based (TB) PPDUs.

19. The method of claim 16, further comprising:
negotiating, by the processor, with the sharing AP to select one of a plurality of TXOP sharing modes used by all APs in a coordinated time-division multiple-access (C-TDMA) group in sharing the TXOP.

20. The method of claim 19, wherein the plurality of TXOP sharing modes comprise:
a first TXOP sharing mode requiring the sharing AP to share the TXOP equally among all the APs in the C-TDMA group;
a second TXOP sharing mode requiring the sharing AP to allocate sharing times of the TXOP to All the APs in the C-TDMA group within previously negotiated ranges such that, for APᵢ, a respective TXOP allocation time is in a range of Tₘᵢₙ, APᵢ×a duration of TXOP≤tᵢ≤Tₘₐₓ, APᵢ×the duration of TXOP, and that Σtᵢ≤the duration of TXOP, with Tₘᵢₙ, APᵢ and Tₘₐₓ, APᵢ denoting a minimum sharing time and a maximum sharing time with respect to AP, and with tᵢ denoting a respective TXOP allocation time for APᵢ;
a third TXOP sharing mode requiring the sharing AP to maintain an aggregate equal-time rule between any pair of two APs of all the APs in the C-TDMA group such that T_{i,j}=T_{j,i}, with T_{i,j} and T_{j,i} denoting a total amount of time allocated by APᵢ to APⱼ and a total amount of time allocated by APⱼ to APᵢ, respectively, after a number M of TXOPs, and with M being a positive integer; and
a fourth TXOP sharing mode requiring the sharing AP to compute allocation times t1, t2, . . . by computing tᵢ=Ni/(Σᵢ₌₁ . . . _{L} Nᵢ)*the duration of TXOP for all i=1, . . . , L, with L being a number of APs in the C-TDMA group and Nᵢ denoting a number of STAs being served by APᵢ.
